(19) United States
(12) Patent Application Publication
(10) Pub. No.: US 2005/0048814 A1
(43) Pub. Date: Mar. 3, 2005

(54) Earth metal fitting and earth structure for jacks of electronic devices

(76) Inventor: Kazunori Kunimoto, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/927,282

(22) Filed: Aug. 27, 2004

(30) Foreign Application Priority Data
Aug. 28, 2003 (JP) 2003-209237

(51) Int. Cl. H01R 13/648

(52) U.S. Cl. 439/95

(57) ABSTRACT

To provide an earth structure for electronic devices, capable of being fixed to an electronic device and improving the shielding effect thereof even when a cylindrical portion of a jack is fitted in a resin panel, and even when the intervals of jacks are small, an earth metal fitting has a front metal plate having at least a jack hole, a recess is formed in at least upper or lower portion of the jack hole to form an elongated contact member extending from a bottom portion of the recess so as to project to a position on an inner side of an inner circumference of the jack hole so that the contact member is engaged in a bent state with a cylindrical portion of the jack to be fitted in the jack hole.

### BACKGROUND OF THE INVENTION

1. Field of the Invention

The present invention relates to an earth metal fitting and an earth structure for jacks of electronic devices, provided so as to enable a single or plural plug or plugs to be connected to a part of an electronic device through a single or plural hole or holes made in a cabinet thereof.

2. Related Art

As shown in FIGS. 7(a) and 7(b), a front panel or a rear panel of an electronic device is provided with jacks for connecting the electronic device to an external electronic device. FIG. 7(a) shows jacks provided in the front panel, and FIG. 7(b) shows jacks provided in the rear panel. When the jacks are provided in the front panel, the jacks include a picture input jack “j”, left and right jacks “k”, “i” for voice input jacks, and a jack “m” for a S-terminal.

On the other hand, when the jacks are provided in the rear panel, the jacks include an image input jack “j”, left and right jacks “k”, “i” for voice input jacks, a jack “m” for a S-terminal, and input and output jacks “n”, “o” for an antenna. These jacks are earthed so as to prevent the electronic device from encountering troubles of electromagnetic waves. There are various earth structures for these jacks. As a general earth structure, a metal fitting is fitted around an outer circumference of a cylindrical portion of a jack housing, and the jacks are connected to the rear panel via the metal fitting.

As shown in FIGS. 8(a) to 8(c), the “JACK WITH EARTH HARDWARE” disclosed in JP-A-11-121105 is structured by providing an inner leaf spring “b” and an outer leaf spring “c” on an earth metal fitting “a”, holding the earth metal fitting “a” between a jack and a terminal panel “d”, bringing the inner leaf spring “b” into contact with a cylindrical portion “e” of the jack, and bringing the outer leaf spring “c” into contact with the terminal panel “d”. However, in this earth structure, a clearance “i” between an outer circumference of the cylindrical portion “e” of the jack and an inner circumference of a hole for the earth metal fitting “a” is large, so that a shielding effect of the earth metal fitting is not satisfactorily high. Since inner leaf springs “b”, “b” . . . are provided on upper, lower, left and right portions of an inner circumferential surface of the hole mentioned above, the intervals at which the jacks are arranged become large, and this necessarily hampers the miniaturization of the electronic device.

As shown in FIG. 8(d), “ELECTRONIC APPARATUS” disclosed in JP-A-6-76885 is structured by providing a first contact portion “f” and a second contact portion “g” on an earth metal fitting “a”, holding the earth metal fitting between a jack and a terminal panel “d”, engaging the first contact portion “f” with an inner surface of the terminal panel “d”, and engaging the second contact portion “g” with a ground of a cylindrical portion “e” of the jack. Since this earth metal fitting has a three-dimensional solid shape having the first contact portion “f” and second contact portion “g”, the manufacturing of the earth metal fitting is troublesome. It is not easy to form the earth metal fitting to adapt to a plurality of jacks arranged on a panel of an electronic device. Therefore, the earth metal fittings have to be fixed to the respective jacks.

As shown in FIG. 8(e), “ELECTRIC WAVE LEAKAGE PREVENTING STRUCTURE FOR RCA JACKS AND REAR PANELS” disclosed in JP-U-3095000 is provided on a jack with an earth metal fitting “a” connected to a ground terminal, and on a terminal panel “d” with a claw “h”. When the jack is fastened tightly to the terminal panel “d” with a screw, the claw “h” of the terminal panel “d” comes into contact with the earth metal fitting of the jack. In this earth structure, the claw “h” has to be provided on the terminal panel “d”.

Owing to the use of such an earth metal fitting, the jack is in contact with the terminal panel and earthed. However, in case the terminal panel (rear panel) is not a conductive panel like a resin panel, it cannot be earthed. Although the rear panel of a cabinet of an electronic device is made of a metal panel in many cases, a resin panel is used for the front panel for the sake of design. Therefore, when jacks are provided on the front surface of a cabinet, the above-described earth structure has problems.

Thus, the conventional earth structures for electronic devices have such problems as described above.

### SUMMARY OF THE INVENTION

The present invention is to solve are such problems as referred to above. One object of the present invention is to provide an earth structure for electronic devices, capable of being fixed to an electronic device even when cylindrical portions of jacks are fitted in a resin panel, and even when the intervals of the jacks are small; and capable of reducing a clearance between an outer surface of a cylindrical portion of each jack and an inner surface of a hole in which this cylindrical portion is fitted of an earth metal fitting, and thereby improving the shielding effect of the earth metal fitting.

An earth metal fitting for jacks of an electronic device according to the present invention comprises a front metal plate having at least a jack hole, a recess formed in at least upper or lower portion of the jack hole, and an elongated contact member extending from a bottom portion of the recess so as to project to a position on an inner side of an inner circumference of the jack hole so that the contact member is engaged in a bent state with a cylindrical portion of the jack to be fitted in the jack hole. A clearance between an inner surface of the jack hole in which the cylindrical portion of the jack is fitted and an outer surface of the cylindrical portion of the jack is set small so as to improve the shielding effect of the earth metal fitting.

When a cabinet of an electronic device is formed from a metal, the earth structure for jacks of electronic devices according to the present invention comprises a front metal plate having at least a jack hole, recesses formed in upper and lower portions of the jack hole, and elongated contact members extending from bottom portions of the recesses so as to project to positions on an inner side of an inner circumference of the jack hole, one contact member being engaged in a bent state with a cylindrical portion of the jack fitted in the jack hole, the other contact member being engaged with a metal panel of the cabinet.

When a cabinet panel of an electromagnetic machine is formed from a nonconductive material, the earth structure for jacks of electronic devices according to the present invention a front metal plate having at least a jack hole, a recess formed in at least upper or lower portion of the jack hole, and an elongated contact member extending from a bottom portion of the recess toward a position on an inner side of an inner circumference of the jack hole, the contact member being engaged in a bent state with a cylindrical portion of the jack fitted in the jack hole, a bottom plate formed by bending a lower end portion of the front metal plate being engaged with a metal chassis.

### BRIEF DESCRIPTION OF THE DRAWING

FIG. 1(a) is a front view of an embodiment of the earth metal fitting according to the present invention, FIG. 1(b) is a plan view of the same, and FIG. 1(c) is a left side view of the same;

FIG. 2 is an enlarged view of jack holes of the earth metal fitting;

FIG. 3(a) is a side elevation view of an earth structure using the earth metal fitting, FIG. 3(b) is a section view taken along an arrow line 3(b)-3(b) in FIG. 3(a);

FIG. 4(a) is a perspective view showing a jack for A S-terminal, FIG. 4(b) is a side elevation view showing a mode of fixing the jack for the S-terminal;

FIG. 5(a) is a side elevation view showing another embodiment of the earth structure, FIG. 5(b) is a sectional view taken along an arrow-carrying line 5(b)-5(b) in FIG. 5(a);

FIG. 6(a) is a side elevation view showing still another embodiment of the earth structure;

FIG. 6(b) is a sectional view taken along an arrow-carrying line 6(b)-6(b) in FIG. 6(a);

FIG. 7(a) is a perspective view showing an electronic device provided with jacks in a front panel thereof, FIG. 7(b) is a perspective view showing an electronic device provided with jacks in a rear panel thereof;

FIG. 8(a) is a side elevation view showing a conventional earth structure, FIGS. 8(b) and 8(c) are a front view and a side elevation view thereof; and

FIGS. 8(d) and 8(e) are side elevation views of still another related art earth structures.

### DETAILED DESCRIPTION OF PREFERRED EMBODIMENT

An embodiment of the present invention will now be described in detail on the basis of what are shown in the drawings.

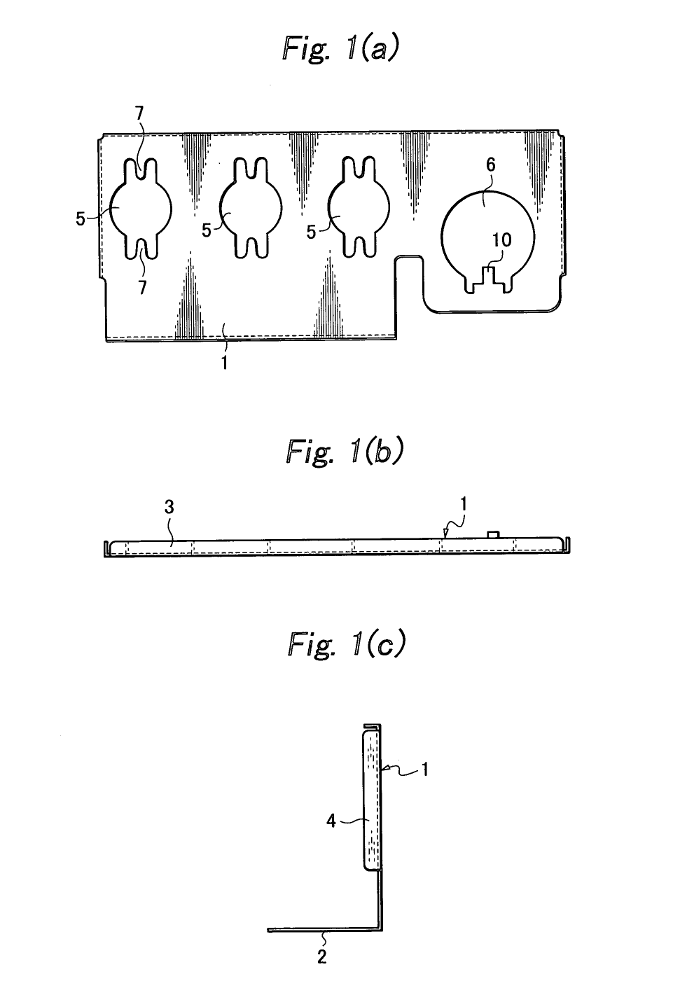

FIGS. 1(a) to 1(c) show an embodiment of the earth metal fitting according to the present invention, which is made of an L-shaped body having substantially rectangular front plate 1 and bottom plate 2, the front plate 1 being provided at an upper edge with an upper edge member 3, and at both sides thereof with side edge members 4, 4 formed so as to be bent rearward. The front plate 1 is provided with three jack holes 5 and one jack hole 6 for one jack for A S-terminal. These jack holes are provided with contact members 7, 7 respectively.

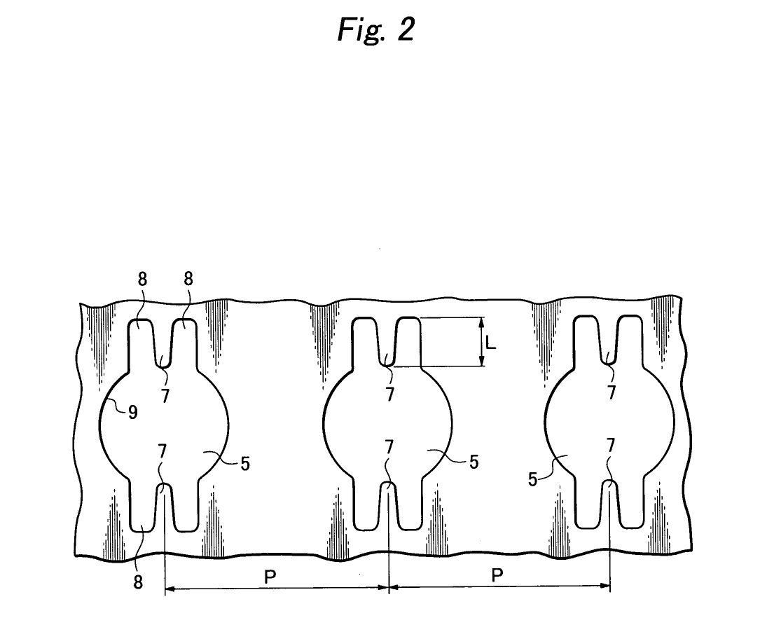

FIG. 2 shows on an enlarged scale a mode of arrangement of the jack holes 5.

The jack holes 5 are arranged with a pitch P. Each jack hole 5 is provided in upper and lower portions thereof with two recesses 8, 8 respectively, and contact members 7, 7 extending toward the center of the jack hole 5 are thereby formed in the central portions of the recesses. The free ends of the projecting contact members 7, 7 extend to a position on the slightly inner side of an inner circumference 9 of the jack hole 5, and can be engaged in a bent state with an outer circumferential surface of a cylindrical portion of a jack to be fitted in the jack hole 5.

The contact member 7 extends from a bottom portion of the recess 8, and the length L thereof is comparatively large. When the contact member engages the cylindrical portion of the jack fitted in the jack hole 5, the contact member is bent, and an imperfect engagement of the contact member with the jack does not occur. Namely, the narrow and long contact member 7 is bent freely in accordance with the thickness of the cylindrical portion of the fitted jack and engages the same. Since the contact members 7, 7 are formed in the upper and lower portions of the jack hole 5, the pitch P of the jack holes 5 can be set smaller, and the cylindrical portions of the jacks can be arranged with a smaller pitch P as a result.

On the other hand, the jack hole 6 for a S-terminal is formed to a larger size than these jack holes 5, and, moreover, a contact member 10 is provided only in a lower side of the jack hole 6 (refer to FIG. 1(a)). Unlike the contact members 7, the contact member 10 is not provided with a recess cut downward greatly. The contact member 10 is formed so that the same contact member is bent rearward and engaged with the cylindrical portion of the jack easily as will be described later.

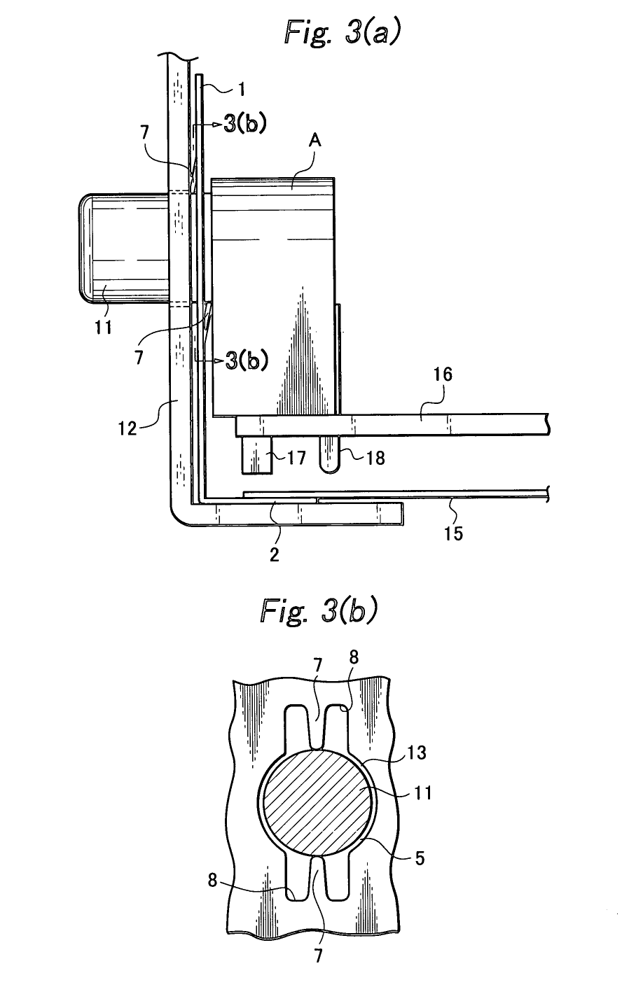

FIGS. 3(a) and 3(b) show an earth structure in a case where an earth metal fitting 1 is fixed to a front resin panel 12 of an electronic device. This front panel 12 is formed from a resin, and not from a conductive material. Therefore, the bottom plate 2 of the L-shaped earth metal fitting 1 is held between a metal chassis 15 and a bottom plate of the L-shaped panel 12, and contacts the chassis 15. The jack A has a fixing member 17 and a terminal 18, and is fixed to a circuit board 16 by the fixing member 17 and joined to the circuit board by the terminal 18. The front panel 12 is provided therethrough with a hole, from which the cylindrical portion 11 of the jack projects.

In the jack hole 5 of the earth metal fitting 1, the cylindrical portion 11 of the jack A is fitted with the two contact members 7, 7 bent in the mutually opposite directions. In order to have the jack A fitted in the jack hole 5 with the contact members 7, 7 bent in the mutually opposite directions, the fitting of the cylindrical portion 11 into the jack hole 5 may be done diagonally. When the cylindrical portion 11 of the jack is inserted into the jack hole 5 in parallel with the axis thereof, the two contact members 7, 7 are bent toward the front panel 12, of course, but a problem does not arise because the bottom plate 2 is in contact with the metal chassis 15.

The cylindrical portion 11 of the jack is connected to the chassis 15 via the earth metal fitting 1a and earthed. A clearance 13 between the inner circumference of the jack hole 5 and the outer surface of the cylindrical portion 11 of the jack fitted in the jack hole is small, so that the shielding effect for preventing the entry of electromagnetic waves from the clearance 13 is improved. According to the present invention, the recesses 8, 8 extending in the vertical direction are formed in the jack hole 5 so as to reduce the clearance 13, and the elongated contact members 7, 7 extending from the bottom portions of the recesses are provided. In order to form the clearance 13 to a large size, it is not necessary to form the recesses and contact members extending from the bottom portions of the recesses. Namely, longer contact members can be provided within the range of the large recesses, and can be engaged in a bent state with the cylindrical portion of the jack fitted in the jack hole. However, the shielding effect is spoiled due to the increased clearance. According to the present invention, a high shielding effect and an excellent engagement of the contact members with the cylindrical portion of the jack fitted in the jack hole can stand together.

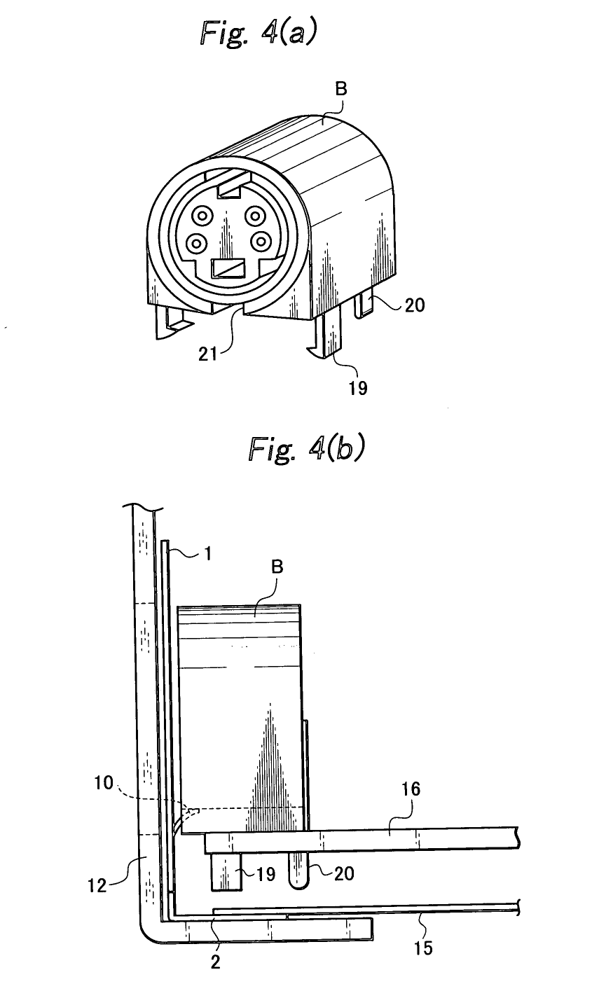

FIG. 4(b) shows an earth structure with such a jack B for a S-terminal as shown in FIG. 4(a) fixed in a position corresponding to a jack hole 6. The jack B for a S-terminal is also fixed to a circuit board 16 by a fixing member 19 in the same manner as the jack A, and connected to the circuit board by a terminal 20. The jack B for a S-terminal is molded at an outer circumference thereof by a resin layer as shown in the drawing, and cut off at a lower portion thereof to form a recess 21. In a front surface of the jack B for a S-terminal is provided with a jack hole 6 for an earth metal fitting 1, and a contact member 10 extends being bent backward diagonally to engage a cylindrical portion of the metal jack in the recess 21.

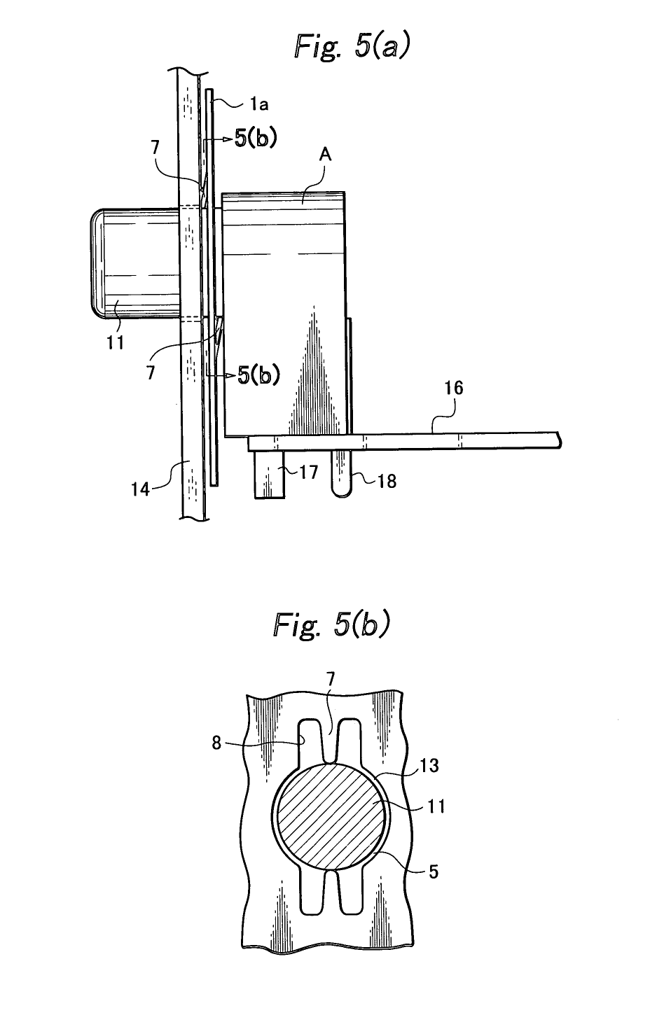

FIGS. 5(a) and 5(b) show another mode of earth structure with an earth metal fitting 1a fixed to a rear metal panel 14. The earth metal fitting 1a is fixed to the rear metal panel 24, and a cylindrical portion 11 of a jack A is fitted in a jack hole 5. The earth metal fitting 1a is not provided with such a bottom plate 2 as shown in FIG. 1. The earth metal fitting 1a fixed to the cylindrical portion 11 of a jack is held between the jack A and rear panel 14. The rear panel 14 is provided with a trough hole, from which the cylindrical portion 11 of the jack projects.

Contact members 7, 7 formed on the earth metal fitting 1a engage the cylindrical portion 11 of the jack. The elongated contact members 7, 7 can be deformed by engaging the cylindrical portion 11 of the jack. Out of the two, i.e. upper and lower contact members 7, 7, one contact member 7 is bent toward the side of the jack A, and the other 7 toward the side of the rear panel 14. The two contact members 7, 7 engage the cylindrical portion 11 of the jack, and the contact member 7 bent toward the side of the rear panel 12 engages the rear panel 12 as well. Since the rear panel 12 is made of a metal, the cylindrical portion 11 of the jack is joined to the rear panel 12 via the earth metal fitting 1a and earthed.

In order to bend the two contact members 7, 7 in opposite directions each other, the cylindrical portion 11 of the jack may be fitted diagonally as mentioned above into the jack hole 5 of the earth metal fitting A. The cylindrical portion 11 of the jack may also be inserted into the jack hole 5 in parallel with the central axis thereof to bend the two contact members 7, 7 toward the side of the rear panel 14. The reason is that free end portions of the two contact members 7, 7 are engaged with the cylindrical portion 11 of the jack and the rear panel 14.

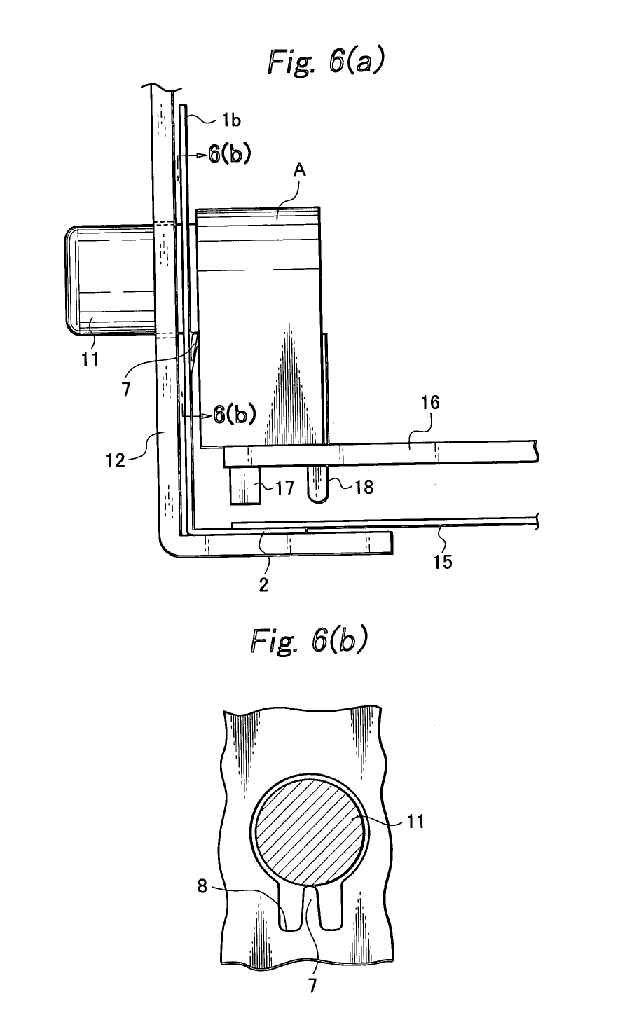

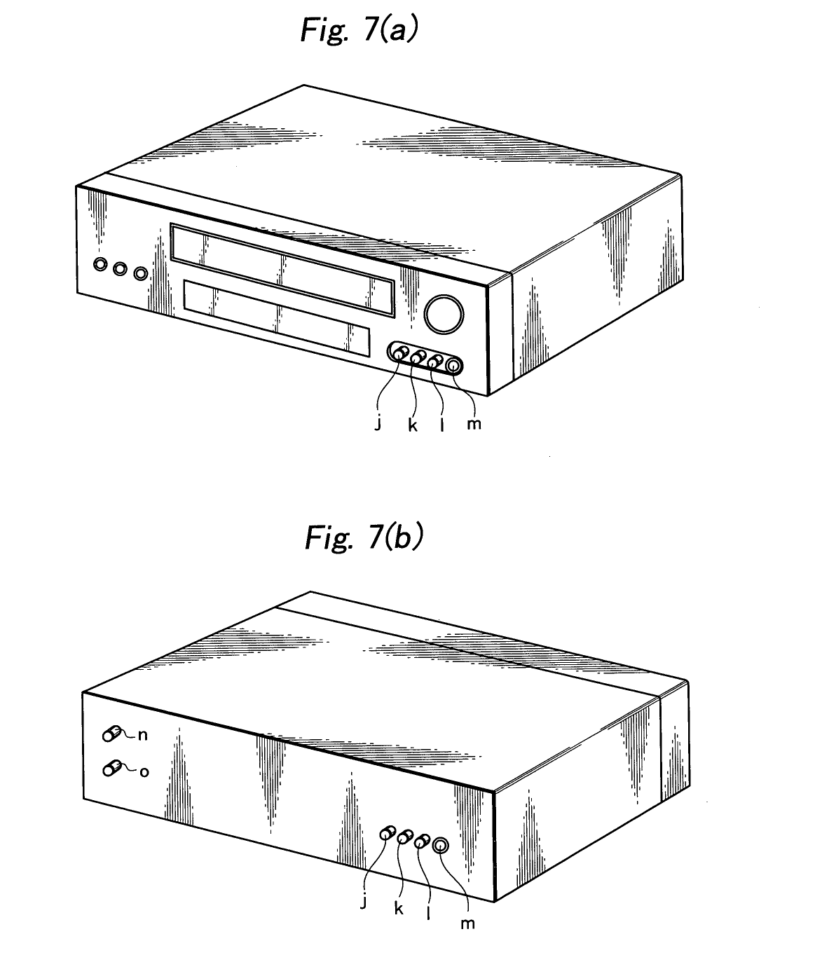

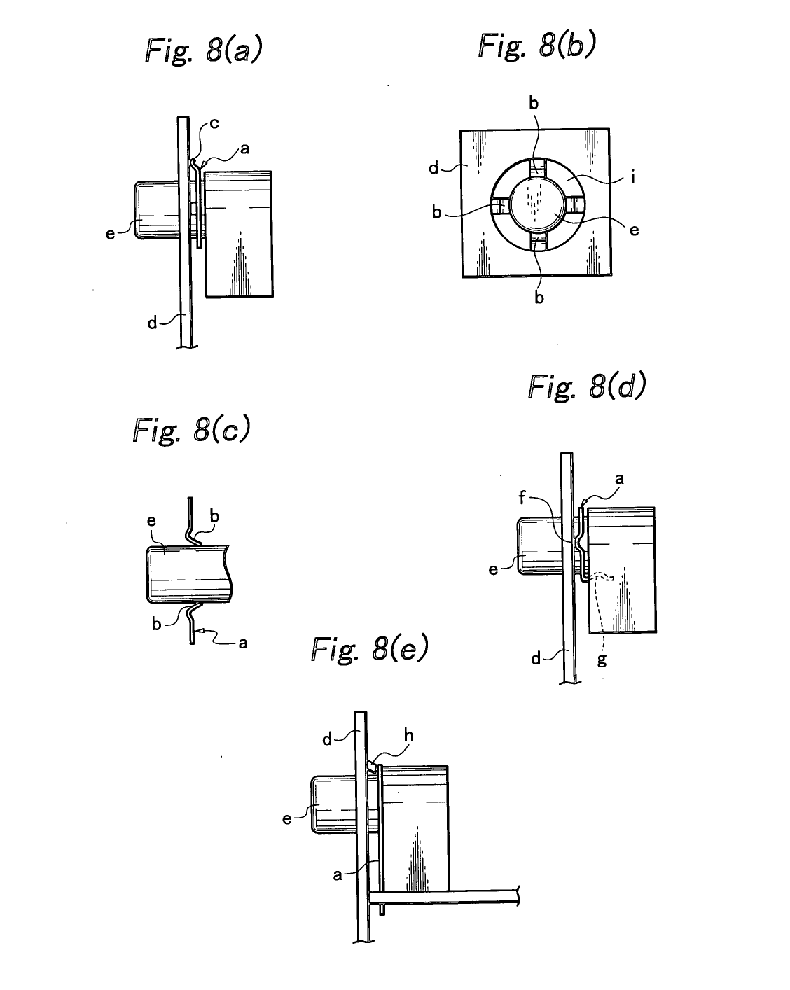

FIGS. 6(a) and 6(b) show still another mode of the earth structure with an earth metal fitting 1b fixed to a front resin panel 12. A difference between this embodiment and the embodiment of FIG. 3(a) resides only in that a contact member 7 of the former is provided in a lower portion alone of a jack hole 5 of the earth metal fitting 1b. Namely, a recess 8 is formed only in a lower portion of the jack hole 5, and the contact member 7 is extended from a bottom portion of this recess, a free end portion of the contact member 7 being engaged in a bent state with a cylindrical portion 11 of a jack A. Even when a rear panel is made of a resin, the same earth structure can be applied, of course.

Although the earth metal fitting shown in FIG. 1 is formed for a four-jack-carrying electronic device, the number of the jacks is not specially limited. The earth metal fitting can also be formed for one-jack-carrying electronic device. The earth metal fitting according to the present invention is provided as described above with recesses in the upper and/or lower portions of a jack hole formed in the front plate, and contact members are extended from the bottom portions of the recesses. The present invention can attain the following effects.

In the earth metal fitting according to the present invention, the contact members are extended from the bottom portions of the recesses formed by cutting a jack hole upward and/or downward. Therefore, the length of the contact members is large, and the contact members can be engaged in a bent state with the cylindrical portion of the jack, so that an imperfect engagement of the contact members with the jack does not occur. Since the recesses and contact members are provided so as to extend vertically, the intervals of the jack holes can be set smaller. This enables the intervals of the jacks fixed to the circuit board to be reduced, and the electronic device to be miniaturized.

The earth metal fitting can be fixed even when the cylindrical portion of a jack is fitted in a resin panel. It is also possible to reduce the clearance between the outer circumference of the cylindrical portion of the jack and the inner circumference of the hole, in which the same cylindrical portion is fitted, of the earth metal fitting, prevent the entry of external electromagnetic waves into the electronic device, and thereby improve the shielding effect.

1. An earth metal fitting for jacks of electronic devices, adapted to earth jacks provided in front, rear or side surface of a cabinet of an electronic device so as to connect the jacks to another device, comprising a front metal plate having at least a jack hole, a recess formed in at least upper or lower portion of the jack hole, and an elongated contact member extending from a bottom portion of the recess so as to project to a position on an inner side of an inner circumference of the jack hole so that the contact member is engaged in a bent state with a cylindrical portion of the jack to be fitted in the jack hole.

2. An earth structure for jacks of electronic devices, adapted to earth jacks provided in front, rear or side surface of a cabinet of an electronic device to connect the jacks to another device, comprising a front metal plate having at least a jack hole, recesses formed in upper and lower portions of the jack hole, and elongated contact members extending from bottom portions of the recesses so as to project to positions on an inner side of an inner circumference of the jack hole, one contact member being engaged in a bent state with a cylindrical portion of the jack fitted in the jack hole, the other contact member being engaged with a metal panel of the cabinet.

3. An earth structure for jacks of electronic devices, adapted to earth jacks provided in front, rear or side surface of a cabinet of an electronic device so as to connect the jack to another device, comprising a front metal plate having at least a jack hole, a recess formed in at least upper or lower portion of the jack hole, and an elongated contact member extending from a bottom portion of the recess toward a position on an inner side of an inner circumference of the jack hole, the contact member being engaged in a bent state with a cylindrical portion of the jack fitted in the jack hole, a bottom plate formed by bending a lower end portion of the front metal plate being engaged with a metal chassis.
